(19) United States
(12) Patent Application Publication
(10) Pub. No.: US 2022/0312568 A1
(43) Pub. Date: Sep. 29, 2022

(54) METHODS AND SYSTEMS OF DETECTING FAULTS IN CIRCUITS DRIVING AVERAGE-CURRENT LOADS

(71) Applicant: SEMICONDUCTOR COMPONENTS INDUSTRIES, LLC, Phoenix, AZ (US)

(72) Inventors: Pascal TOURNIER, Tournefeuille (FR); Sebastien BRAS, Rabastens (FR); Dominique ROMEO, Montauban (FR)

(73) Assignee: SEMICONDUCTOR COMPONENTS INDUSTRIES, LLC, Phoenix, AZ (US)

(21) Appl. No.: 17/654,951

(22) Filed: Mar. 15, 2022

Related U.S. Application Data
(60) Provisional application No. 63/200,743, filed on Mar. 25, 2021.

(51) Int. Cl. H05B 45/50; H05B 45/3725; H02M 1/00; H02M 3/158

(52) U.S. Cl. CPC H05B 45/50; H05B 45/3725; H02M 1/0009; H02M 3/158

(57) ABSTRACT

Detecting faults in circuits driving average-current loads. At least one example is a method comprising: conducting, during a first half-period of a drive cycle, a first current through a first FET to an inductor and an average-current load (e.g., an LED); sensing, during the first half-period, a signal indicative of average current through the first FET; and then conducting, during a second half-period of the drive cycle, a second current through a second FET to the inductor and the average-current load; sensing, during the second half-period, a signal indicative of average current through the second FET; and asserting a fault signal if the signal indicative of average current through the second FET indicates an average current supplied to the average-current load is outside a predetermined range of values.

### CROSS-REFERENCE TO RELATED APPLICATIONS

This application claims the benefit of provisional application No. 63/200,743 filed Mar. 25, 2021 titled “Regulation and Monitoring Circuits.” The provisional application is incorporated by reference herein as if reproduced in full below.

### BACKGROUND

Light-emitting diodes (LEDs) are increasingly popular for lighting systems for a variety of reasons. The reasons may include greater light produced per unit of energy supplied to the LED (compared to, for example, incandescent bulbs), and controllability of the LEDs. The increased popularity of LEDs is also true within the automotive industry.

At least in the context of the automotive industry, LEDs are controlled by controlling average current through the LEDs. Related-art control techniques directly measure current through the LEDs by way of a shunt resistor. However, even using a low value resistance as the shunt resistor, use of a shunt resistor results in sensing losses and thus lower overall efficiency of the LED driving circuit. Moreover, using a single-point of reference for measuring current through the LEDs provides no basis for a redundant current measurement for functional safety monitoring for circuit/device failure detection (e.g., ISO 26262 ASIL).

### SUMMARY

One example is a method comprising: conducting, during a first half-period of a drive cycle, a first current through a first FET to an inductor and an average-current load;

sensing, during the first half-period, a signal indicative of average current through the first FET; and then conducting, during a second half-period of the drive cycle, a second current through a second FET to the inductor and the average-current load; sensing, during the second half-period, a signal indicative of average current through the second FET; and

asserting a fault signal if the signal indicative of average current through the second FET indicates an average current supplied to the average-current load is outside a predetermined range of values.

In the example method, conducting the first current may further comprise driving current through the first FET during a charge mode of the inductor during the drive cycle, and conducting current through the second FET may further comprise conducting current through the second FET during a discharge mode of the inductor during the drive cycle.

In the example method, sensing the signal indicative of average current through the first FET may further comprise reading a signal indicative of voltage drop across the first FET, sensing the signal indicative of average current through the second FET may further comprise reading a signal indicative of voltage drop across the second FET.

In the example method, sensing the signal indicative of average current through the first FET may further comprise measuring a voltage drop across the first FET, and sensing the signal indicative of average current through the second FET may further comprise measuring a voltage drop across the second FET.

The example method may further comprise: generating a sawtooth waveform that corresponds to the first current and the second current; wherein sensing the signal indicative of average current through the first FET may further comprise sampling to create the signal indicative of average current through the first FET, the sampling at a point in time within the first half-period when the sawtooth waveform crossing a signal indicative of setpoint average current; and wherein sensing the signal indicative of average current through the second FET may further comprise sampling to create the signal indicative of average current through the second FET, the sampling at a point in time within the second half-period corresponding to the sawtooth waveform crossing the signal indicative of setpoint average current.

In the example method, sensing the signal indicative of average current through the first FET may further comprise measuring a voltage drop across or current through a first mirror-FET associated with the first FET, and sensing the signal indicative of average current through the second FET may further comprise measuring a voltage drop across or current through a second mirror-FET associated with the second FET.

Another example is a driver for an LED, the driver comprising: a setpoint terminal, an input-voltage terminal, a switch-node terminal, and a return terminal; a high-side FET defining drain coupled to the input-voltage terminal, a source coupled to the switch-node terminal, and a gate; a low-side FET defining a drain coupled to the switch-node terminal, a source coupled to the return terminal, and a gate; a regulator defining a setpoint input coupled to the setpoint terminal, a high-gate output coupled to the gate of the high-side FET, and a low-gate output coupled to the gate of the low-side FET, the regulator configured to assert the high-gate output and de-assert the low-gate output to create charge modes of an inductor, and the regulator configured to de-assert the high-gate output and assert the low-gate output to create discharge modes of the inductor; the regulator configured to control an on-time of each charge mode based on a first signal indicative of average current to the switch-node terminal; and a monitor circuit coupled to the switch-node terminal, the monitor circuit configured to sense a second signal indicative of average current to the switch-node terminal and assert a fault signal if the second signal indicative of average current to the switch-node terminal is outside a predetermined range of values.

In the example driver, when the monitor circuit senses the second signal indicative of average current to the switch-node terminal, the monitor circuit may read a signal indicative of voltage drop across the low-side FET during a discharge mode. The example driver may further comprise: a low-mirror FET having a bulk region adjacent to a bulk region of the low-side FET, the low-mirror FET defining a first connection coupled to the switch-node terminal, a second connection coupled to a reference voltage, and a gate coupled to the gate of the low-side FET; wherein when the monitor circuit reads the signal indicative of voltage drop across the low-side FET, the monitor circuit may measure a voltage drop across or current through the low-mirror FET. In the example driver, the regulator may be further configured determine the first signal indicative of average current to the switch-node terminal by reading a signal indicative of voltage drop across the high-side FET during a charge mode. The example driver may further comprise: a high-mirror FET having a bulk region adjacent to a bulk region of the high-side FET, the high-mirror FET defining a first connection coupled to input-voltage terminal, a second connection coupled to a reference voltage, and a gate coupled to the gate of the high-side FET; wherein when the regulator reads the signal indicative of voltage drop across the high-side FET, the regulator may measure a voltage drop across or current through the high-mirror FET.

In the example driver, when the monitor circuit senses the second signal indicative of average current to the switch-node terminal, the monitor circuit may read a signal indicative of voltage drop across the high-side FET during a charge mode. In the example driver, the regulator may be further configured determine the first signal indicative of average current to the switch-node terminal by reading a signal indicative of voltage drop across the low-side FET during a discharge mode.

Another example is an LED module comprising: an LED; an inductor defining a first lead coupled to an anode of the LED, and a second lead defining a switch node; a setpoint resistor defining a first lead coupled to a reference voltage and a second lead, a resistance of the setpoint resistor is proportional to a setpoint average current for the LED; and a driver. The driver may comprise: high-side FET defining a drain coupled to a input voltage, a source coupled to the switch node, and a gate; a low-side FET defining a drain coupled to the switch node, a source coupled to a return, and a gate; regulator defining a setpoint input coupled to the second lead of the setpoint resistor, a high-gate output coupled to the gate of the high-side FET, and a low-gate output coupled to the gate of the low-side FET, the regulator configured to drive a plurality of charge modes and discharge modes of the inductor based on a first signal indicative of average current to the switch node; and a monitor circuit coupled to the switch node, the monitor circuit configured to sense a second signal indicative of average current to the switch node and assert a fault signal if the second signal indicative of average current to the switch node is outside a predetermined range of values.

In the example LED module, when the monitor circuit senses the second signal indicative of average current to the switch node, the monitor circuit may read a signal indicative of voltage drop across the low-side FET during a discharge mode. In the example LED module, the driver may further comprise: a low-mirror FET having a bulk region adjacent to a bulk region of the low-side FET, the low-mirror FET defining a first connection coupled to the switch node, a second connection coupled to a reference voltage, and a gate coupled to the gate of the low-side FET; wherein when the monitor circuit reads the signal indicative of voltage drop across the low-side FET, the monitor circuit may measure a voltage drop across the low-mirror FET. In the example LED module, the regulator may be further configured to determine the first signal indicative of average current to the switch node by reading a signal indicative of voltage drop across the high-side FET during a charge mode. In the example LED module, the driver may further comprise: a high-mirror FET having a bulk region adjacent to a bulk region of the high-side FET, the high-mirror FET defining a first connection coupled to the input voltage, a second connection coupled to a reference voltage, and a gate coupled to the gate of the high-side FET; wherein when the regulator reads the signal indicative of voltage drop across the high-side FET, the regulator may measure a voltage drop across the high-mirror FET.

In the example LED module, when the monitor circuit senses the second signal indicative of average current to the switch node, the monitor circuit may read a signal indicative of voltage drop across the high-side FET during a charge mode. In the example LED module, the regulator may be further configured to determine the first signal indicative of average current to the switch node by reading a signal indicative of voltage drop across the low-side FET during a discharge mode.

In the example LED module, the monitor circuit may further comprise: an LED-current emulator coupled to the switch node and configured to integrate a voltage on the switch node and create a sawtooth waveform having an average value; a comparator having a first input coupled to the sawtooth waveform, a second input coupled to an average signal, and a comparator output, the comparator configured to assert the comparator output when the sawtooth waveform crosses the average signal; a sample-compare circuit coupled to the switch node and the comparator output, the sample-compare circuit configured to measure the second signal indicative of average current to the switch node responsive to assertion of the comparator output; and the sample-compare circuit configured to assert the fault signal if the second signal indicative of average current to the switch node is outside the predetermined range of values.

### BRIEF DESCRIPTION OF THE DRAWINGS

For a detailed description of example embodiments, reference will now be made to the accompanying drawings in which:

FIG. 1 shows a block diagram of an overall system in accordance with at least some embodiments;

FIG. 2 shows a block diagram of a driver circuit in accordance with at least some embodiments;

FIG. 3 shows a block diagram of an example driver circuit in accordance with at least some embodiments;

FIG. 4 shows a block diagram of a monitor circuit in accordance with at least some embodiments;

FIG. 5 shows a timing diagram in accordance with at least some embodiments;

FIG. 6 shows a partial block diagram, partial electrical schematic, of a monitor circuit in accordance with at least some embodiments;

FIG. 7 shows a block diagram of an example driver circuit in accordance with at least some embodiments; and

FIG. 8 shows a method in accordance with at least some embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or a direct connection. Thus, if a first device couples to a second device, that connection may be through a direct connection or through an indirect connection via other devices and connections.

“FET” shall mean field effect transistor, such as a metal-oxide semiconductor FET.

“LED” shall mean light-emitting diode, including one or more LEDs.

In relation to electrical devices (whether stand alone or as part of an integrated circuit), the terms “input” and “output” refer to electrical connections to the electrical devices, and shall not be read as verbs requiring action. For example, a differential amplifier (such as an operational amplifier) may have a first differential input and a second differential input, and these “inputs” define electrical connections to the operational amplifier, and shall not be read to require inputting signals to the operational amplifier.

“Assert” shall mean changing the state of a Boolean signal. Boolean signals may be asserted high or with a higher voltage, and Boolean signals may be asserted low or with a lower voltage, at the discretion of the circuit designer. Similarly, “de-assert” shall mean changing the state of the Boolean signal to a voltage level opposite the asserted state.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various examples are directed to methods and systems of detecting faults in circuits driving average-current loads, such as LEDs. A particular example senses current to the inductor and LEDs during charge modes based a signal indicative of average current through a high-side FET of the driver, and uses the signal indicative of average current through the high-side FET for regulation purposes. The noted example senses current to the inductor and LEDs during discharge modes based on a signal indicative of average current through a low-side FET of the driver, and uses the signal indicative of average current through the low-side FET to monitor performance of the regulation circuitry. That is, if the signal indicative of average current through the low-side FET is outside a predetermined range of values, such is indicative of a fault within the driver and thus a fault signal is asserted. Using the signal indicative of average current through the high-side FET for current regulation purposes, and using the signal indicative of average current through the low-side FET for monitoring purposes is merely an example, and alternatives are presented below. The specification now turns to a high-level system overview to orient the reader.

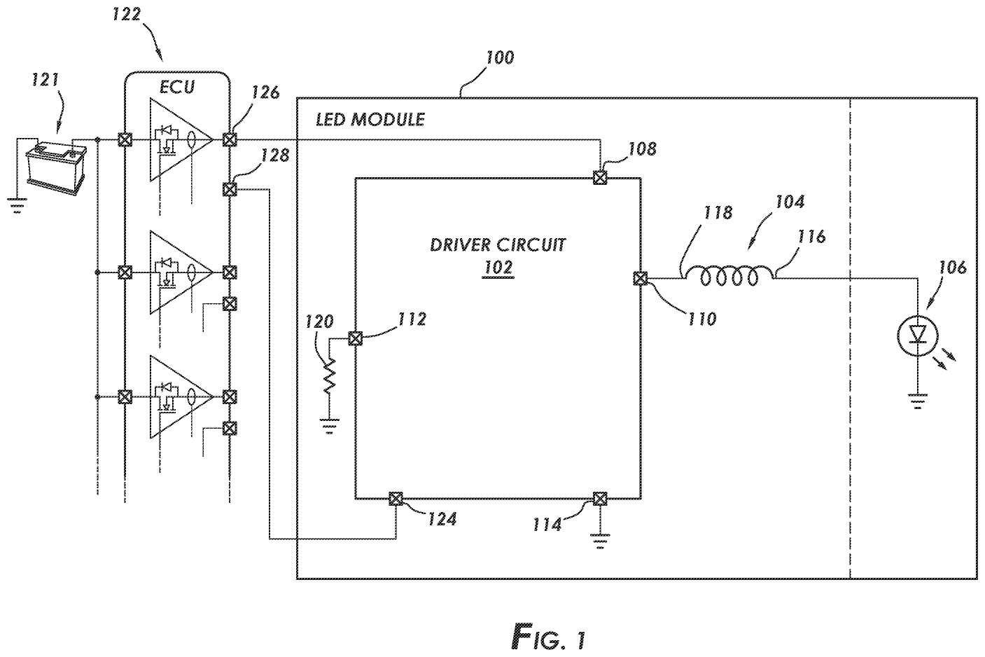

FIG. 1 shows a block diagram of an overall system in accordance with at least some embodiments. In particular, FIG. 1 shows an example LED module 100 comprising a driver circuit 102, an inductor 104, and a LED 106. In some situations, the LED module 100 is a single integrated component (e.g., all devices disposed on one underlying circuit board), but in other situations the LED 106 may be disposed on its own underlying structure (e.g., a bulb assembly) apart from the driver circuit 102 and inductor 104, as illustrated by the dashed line in the figure. The example of FIG. 1 is provided in an automotive context, and thus the overall system further comprises a battery 121 (e.g., 12V automotive battery) as well as an engine control unit (ECU 122).

The driver circuit 102 comprises an input-voltage terminal 108, a switch-node terminal 110, a ground-reference terminal 114, a fault terminal 124, and a setpoint terminal 112. Additional terminals may be present (e.g., enable terminal, serial-communication terminal, diagnostic terminal), but the additional terminals are omitted so as not to unduly complicate the figure. The input-voltage terminal 108 is coupled to a drive output 126 of the ECU 122. In the example shown, the ECU 122 turns on the LED 106 by providing the battery voltage (e.g., 12V) to the drive output 126 and thus input-voltage terminal 108, and correspondingly turns off the LED 106 by removing the battery voltage form the input-voltage terminal 108. The ground-reference terminal 114 is coupled to a ground reference. The setpoint terminal 112 is coupled to a resistor 120, and the resistor 120 is coupled to the ground reference. In the example system, the resistance of the resistor 120 sets or is proportional to a setpoint average current for the LED 106. In other cases, however, the setpoint average current may be communicated to the driver circuit 102 in other forms, such as by serial communications. The fault terminal 124 is coupled to fault input 128 of the ECU 122. When the driver circuit 102 detects an internal fault (e.g., the average current supplied is outside a predetermined range of values), the driver circuit 102 asserts the fault signal on the fault terminal 124, thus alerting the ECU 122 of the fault condition.

The inductor 104 defines a first lead 116 coupled to an anode of the LED 106, and a second lead 118 defining a switch node and thus coupled to the switch-node terminal 110. In the example system, a single LED 106 is shown having an anode coupled to the first lead 116 and a cathode coupled to the ground reference. However, an array of LEDs may be present on the LED module. When an array of LEDs is present, the LEDs may be connected in series, in parallel, and/or a plurality of series-connected LEDs connected in parallel.

In accordance with example embodiments, when enable (e.g., by providing the battery voltage to the input-voltage terminal 108) the driver circuit 102 and the inductor 104 create a voltage applied to the anode of the LED 106. More particularly, the driver circuit 102 and inductor 104 create a time-varying current that defines a sawtooth waveform or sawtooth pattern. During periods of time when the current is rising as part of the sawtooth pattern (e.g., charge modes), current through the LED 106 is rising. During periods of time when the current is falling as part of the sawtooth pattern (e.g., discharge modes), current through the LED 106 is falling. However, the average current driven through the LED 106 (considering both the rising and falling currents over a plurality of cycles) is controlled to a setpoint average current. In example cases, and as shown, the setpoint average current is set or fixed by the resistor 120.

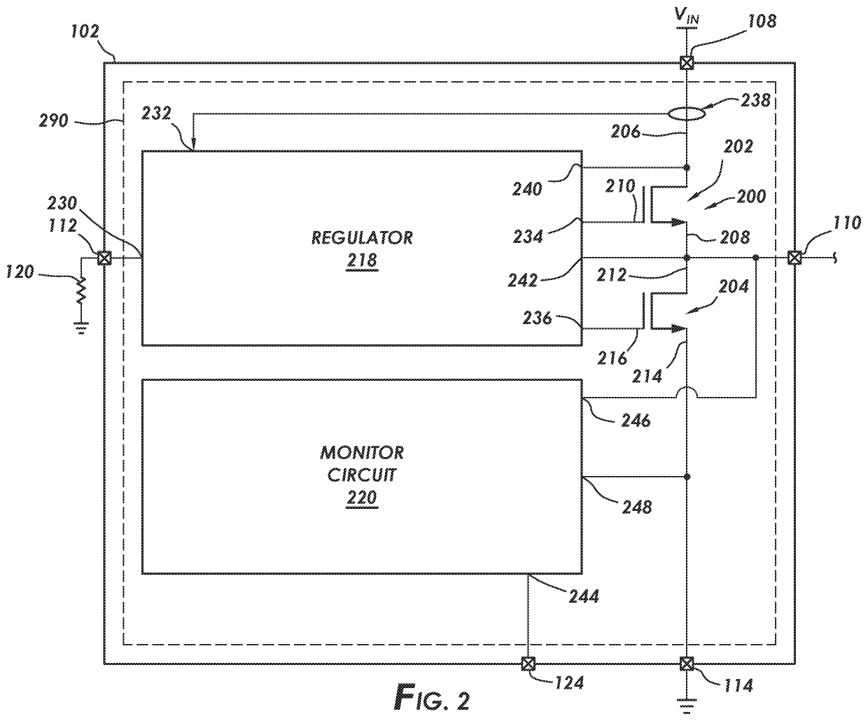

FIG. 2 shows a block diagram of an example driver circuit 102. FIG. 2 shows that the driver circuit 102 may comprise one or more substrates of semiconductor material (e.g., silicon), such as substrate 290, encapsulated within the packaging. Bond pads or other connection points of the substrate 290 couple to electrical terminals of the driver circuit 102 (e.g., terminals 108, 110, 112, 114, and 124). While a single substrate 290 is shown, in other cases multiple substrates may be combined to form the driver circuit 102 (e.g., a multi-chip module), and thus showing a single substrate 290 shall not be construed as a limitation.

The example driver circuit 102 comprises a regulator 218, a monitor circuit 220, and a set of power transistors 200. In particular, the example set of power transistors 200 comprises a high-side FET 202 and a low-side FET 204. The high-side FET 202 defines a current input coupled to the input-voltage terminal 108, a current output coupled to the switch-node terminal 110, and a control input. In the example shown, the high-side FET 202 is N-channel metal-oxide semiconductor FET (MOSFET), and thus the current input is the drain 206, and the current output is the source 208, and the control input is the gate 210. The low-side FET 204 defines a current output coupled to the switch-node terminal 110, a current input coupled to the ground-reference terminal 114, and a control input. In the example shown, the low-side FET 204 is also an N-channel MOSFET, and thus the current output is the drain 212, and the current input is the source 214, and the control input is the gate 216.

The example driver circuit 102 further comprises the regulator 218. The example regulator 218 defines a setpoint input 230 coupled to the setpoint terminal 112, a current-sense input 232, a high-gate output 234 coupled to the gate 210 of the high-side FET 202, and a low-gate output 236 coupled to the gate 216 of the low-side FET 204. In order to supply average current indicated by the resistor 120, the regulator 218 is designed and constructed to drive a plurality of charge modes and discharge modes of the inductor 104 (FIG. 1). More particularly, during each charge mode the regulator 218 asserts the gate 210 of the high-side FET 202 making the FET conductive, and de-asserts the gate 216 of the low-side FET 204 making the FET non-conductive. Current is thus driven or enabled to flow from the input-voltage terminal 108, through the high-side FET 202 to the switch-node terminal 110, and then through the inductor 104 (FIG. 1) and LED 106 (FIG. 1). Because the rate of current flow cannot change instantaneously through an inductance, during each charge mode the current ramps upward and simultaneously energy is stored in the field of the inductor 104.

In the example case, the regulator 218 ends each charge mode based on a peak current sensed through the current-sense input 232. In particular, the example current-sense input 232 is coupled to a current sensor 238 (e.g., a current transformer). Each charge mode ends when a peak current selected for that charge mode is reached. The peak current selected for each charge mode may be different and may be determined based on signal indicative of average current (hereafter just regulation signal). Any suitable regulation scheme may be used in which the peak current selected is raised if average current is low, and the peak current selected is lowered if the average current is high. Nevertheless, in steady-state operation the regulator 218 selects a peak current for each charge mode that results in the setpoint average current being supplied to the inductor 104 and LED 106.

In the example system, the regulation signal may be derived from a signal indicative of voltage drop across the high-side FET 202. That is, during each charge mode the high-side FET 202 is made conductive by assertion of its gate 210. Even when fully conductive, however, the high-side FET 202 presents a small resistance from drain-to-source, the resistance termed Rdson. Thus, current flowing through the high-side FET 202 produces a voltage drop, and the magnitude of the voltage drop is proportional to the magnitude of current flowing through the high-side FET 202. In some cases, the regulation signal is a voltage measurement proportional to the voltage drop across the high-side FET 202 during each charge mode. In the example of FIG. 2, the regulation signal in the form of the voltage drop across the high-side FET 202 is measured directly. In particular, the example regulator 218 defines a first sense input 240 coupled to the drain 206 of the high-side FET 202, and a second sense input 242 coupled to the source 208 of the high-side FET 202 and thus the switch-node terminal 110. That is, in some cases the driver circuit 102 performs the regulation without using an external shunt resistor to measure the current flow from the switch-node terminal 110 to the inductor 104 and LED 106. The example regulator 218 selects the peak current in each charge mode based on the regulation signal. Alternative arrangements for creating the regulation signal are presented below.

Each charge mode is followed by a discharge mode. During each discharge mode, the regulator 218 de-asserts the gate 210 of the high-side FET 202 making the FET non-conductive, and asserts the gate 216 of the low-side FET 204 making the FET conductive. Because of the energy stored in the field of the inductor 104, current continues to flow through the inductor 104. That is, the collapsing field around the inductor draws current through the low-side FET 204 and supplies the current to the inductor 104 and LED 106. Because the field is collapsing, the current ramps downward during each discharge mode. The regulator 218 ends the discharge mode and starts the next charge mode with any suitable timing. In one example, the regulator 218 ends each discharge mode, and thus begins the next charge mode, based on a clock signal with fixed frequency, but again any suitable regulation scheme may be used.

The example driver circuit 102 implements functional safety monitoring by way of the monitor circuit 220. In particular, the example monitor circuit 220 is designed and constructed to sense a signal indicative of average current (hereafter just monitor signal). The monitor circuit 220 assert a fault signal driven to the fault output 244, and thus the fault terminal 124, if the monitor signal is outside a predetermined range of values. Stated otherwise, the monitor circuit 220 asserts the fault terminal 124 if the average current supplied to the LED 106 is outside a predetermined range of values.

In the example system, the monitor signal may be derived from a signal indicative of voltage drop across the low-side FET 204. That is, during each discharge mode the low-side FET 204 is made conductive by assertion of its gate 216. Much like the high-side FET 202, even when fully conductive the low-side FET 204 presents a small resistance from drain-to-source (i.e., Rdson). Thus, current flowing through the low-side FET 204 during each discharge mode produces a small voltage drop, and the magnitude of the voltage drop is proportional to the magnitude of current flowing through the low-side FET 204. In the example of FIG. 2, the voltage drop across the low-side FET 204 is measured directly. In particular, the example monitor circuit 220 defines a first sense input 246 coupled to the drain 212 of the low-side FET 204 (and thus the switch-node terminal 110), and a second sense input 248 coupled to the source 214 of the low-side FET 204 (and thus the ground-reference terminal 114). The example monitor circuit 220 is designed and constructed to create the monitor signal by measuring or sensing the voltage drop across the low-side FET 204 using the first sense input 246 and the second sense input 248. Alternative arrangements for creating the monitor signal are presented below. Again, however, if the monitor signal is outside the predetermined range of values, meaning the overall driver circuit 102 may not be correctly providing the setpoint average current, the fault signal driven to the fault output 244 is asserted.

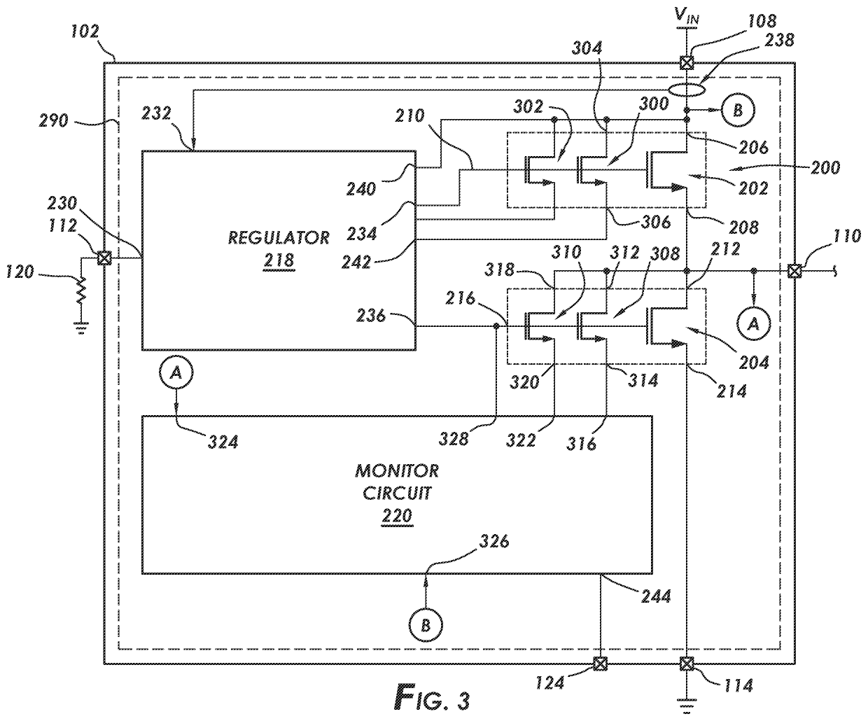

FIG. 3 shows a block diagram of an example driver circuit 102. The example driver circuit of FIG. 3 shares many duplicative elements with the driver circuit of FIG. 2, and those duplicative elements are not introduced again so as not to unduly lengthen the specification. As before, the set of powers transistors 200 comprises the high-side FET 202 and the low-side FET 204. In the case of FIG. 3, the high-side FET 202 is associated with a first high-mirror FET 300 and a second high-mirror FET 302. The example high-mirror FETs 300 and 302 have bulk regions adjacent to a bulk region of high-side FET 202. Stated otherwise, the high-mirror FETs 300 and 302 are constructed on the semiconductor substrate 290 in close proximity to one another and to the high-side FET 202 (e.g., 200 micrometers or less, in some cases 100 micrometers or less). As shown by the common gates 210, the high-side FET 202 and the high-mirror-FETs 300 and 302 are commonly driven. While commonly driven, in many cases the high-mirror FETs 300 and 302 each have a lower current carrying capability (e.g., smaller respective cross-sectional conduction areas) than the high-side FET 202; however, being constructed with bulk regions adjacent to or in close proximity to the high-side FET 202, the high-mirror FETs 300 and 302 experience similar environmental conditions. For that reason, the voltage drop across the high-mirror FETs 300 and/or 302 may be proportional to the voltage drop across the high-side FET 202. Stated otherwise, the Rdson of each of the high-mirror FETs 300 and 302 may be directly proportional to the Rdson of the high-side FET 202. Together the high-side FET 202 and the high-mirror FETs 300 and 302 may be referred to as a SENSEFET™ brand product of ON Semiconductor (now “onsemi”) of Phoenix, Ariz.

In the example of FIG. 3, rather than directly measuring the voltage drop across the high-side FET 202 to create the regulation signal, the example regulator 218 creates the regulation signal by sensing or measuring a voltage drop across one or both of the high-mirror FETs 300 and 302. In particular, the first high-mirror FET 300 defines a drain 304 coupled to the input-voltage terminal 108, and a source 306 coupled to the second sense input 242. Thus, the regulator 218 creates the regulation signal by measuring a voltage drop across the first high-mirror FET 300. That is, in some cases the driver circuit 102 performs the regulation without using an external shunt resistor to measure the current flow from the switch-node terminal 110 to the inductor 104 and LED 106.

One of the failure modes of the driver circuit 102 is a change in the Rdson of the high-side FET 202 during operation (e.g., a non-recoverable over-temperature event). Such a change in the Rdson adversely affects the average current provided to the inductor 104 and the LED 106. The high-mirror FETs 300 and 302, having their bulk regions adjacent to or in close proximity to the bulk region of the high-side FET 202, will likely this experience a similar failure. It follows that the regulator 218 may have no indication that a fault has occurred (e.g., change in Rdson). Other fault conditions within the regulator 218 that affect the average current may also occur.

Still referring to FIG. 3, the low-side FET 204 is associated with a first low-mirror FET 308 and a second low-mirror FET 310. The example low-mirror FETs 308 and 310 have bulk regions adjacent to a bulk region of low-side FET 204. Stated otherwise, the low-mirror FETS 308 and 310 are constructed on the semiconductor substrate 290 in close proximity to one another and to the low-side FET 204 (e.g., 200 micrometers or less, in some cases 100 micrometers or less). As shown by the common gate 216, the low-side FET 204 and the low-mirror-FETs 308 and 310 are commonly driven. While commonly driven, in many cases the low-mirror FETs 308 and 310 each have a lower current carrying capability (e.g., smaller respective cross-sectional conduction areas) than the low-side FET 204; however, being constructed with bulk regions adjacent to or in close proximity to the low-side FET 204, the low-mirror FETs 308 and 310 experience similar environmental conditions. For that reason, the voltage drop across the low-mirror FETs 308 and 310 may be proportional to the voltage drop across the low-side FET 204. Stated otherwise, the Rdson of each of the low-mirror FETs 308 and 310 may be directly proportional to the Rdson of the low-side FET 204. Together the low-side FET 204 and the low-mirror FETs 308 and 310 may be the SENSEFET™ brand product.

In the example of FIG. 3, rather than the monitor circuit 220 directly measuring the voltage drop across the low-side FET 204 to create the monitor signal, the example monitor circuit 220 creates the monitor signal by sensing or measuring a voltage drop across one or both of the low-mirror FETs 308 and 310. In particular, the first low-mirror FET 308 defines a drain 312 coupled to the switch-node terminal 110, and a source 314 coupled to a sense input 316 of the monitor circuit 220. The second low-mirror FET 310 defines a drain 318 coupled to the switch-node terminal 110, and a source 320 coupled to a sense input 322 of the monitor circuit 220. A single one of the low-mirror FETS 308 and 310 may be used to generate the monitor signal. However, in an example implementation, discussed more below, both low-mirror FETs 308 and 310 are used and thus both are shown to couple to the monitor circuit 220. The example monitor circuit 220 further defines a switch-node input 324 coupled to the switch-node terminal 110 (shown by the bubble “A”), a source input 326 coupled to the input-voltage terminal 108 (shown by the bubble “B”), and a mode input 328 coupled to the gate 216. Using the various inputs, the example monitor circuit 220 creates the monitor signal, and when the monitor signal indicates the average current supplied to the switch-node terminal 110 is outside a predetermined range of values, the monitor circuit 220 asserts the fault terminal 124. That is, in some cases the driver circuit 102 performs the monitoring without using an external shunt resistor to measure the current flow from the switch-node terminal 110 to the inductor 104 and LED 106.

A few points to consider before proceed. FIG. 2 shows an example system in which the regulator signal and the monitor signal are created by directly measuring the voltage drop across the high-side FET 202 and the low-side FET 204, respectively. FIG. 3, by contrast, shows an example system in which the regulator signal and the monitor signal are created indirectly by measuring voltage drops across one or more high-mirror FETs 300 and 302 and one or more low-mirror FETS 308 and 310, respectively. However, the direct measurement embodiments of FIG. 2 and the indirect measurement embodiments of FIG. 3 may be mixed and matched. For example, in some cases the regulator signal may be created by the regulator 218 by directly measuring the voltage drop across the high-side FET 202, while the monitor signal may be created indirectly by measuring voltage drop across one or more of the low-mirror FETS 308 and 310. Oppositely, the regulator signal may be created by the regulator 218 by indirectly measuring the voltage drop across the high-side FET 202, while the monitor signal may be created by directly measuring voltage drop across one or more of the low-mirror FETS 308 and 310.

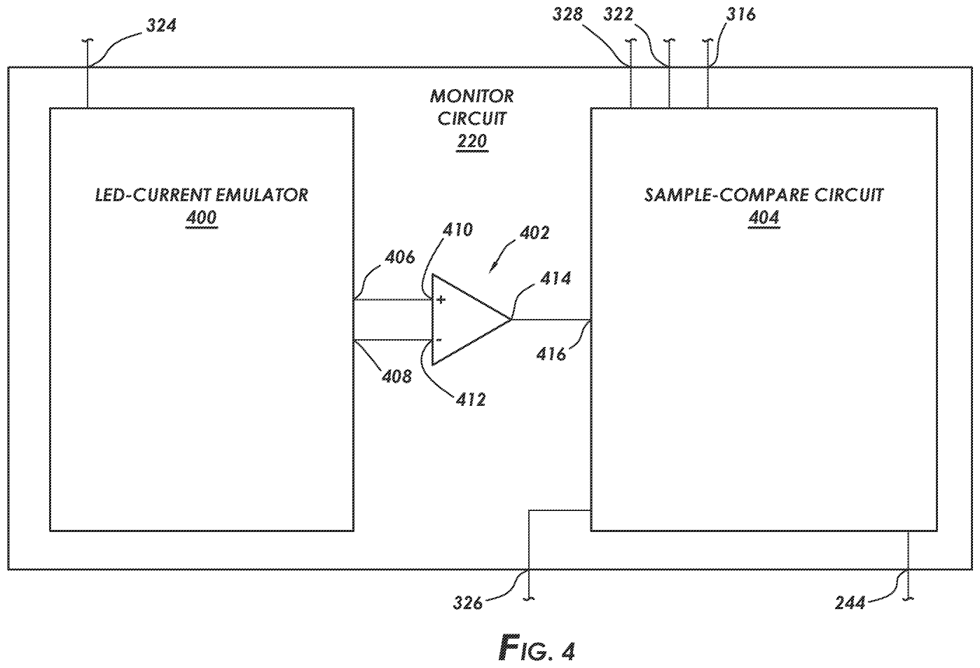

FIG. 4 shows a block diagram of an example monitor circuit 220. In particular, visible in FIG. 4 are the switch-node input 324, the mode input 328, the sense input 322, the sense input 316, the fault output 244, and the source input 326. Using the various inputs, the monitor circuit 220 generates the monitor signal and asserts the fault output 244 if the monitor signal indicates the average current supplied to the switch-node terminal 110 (FIG. 1) is outside a predetermined range of values. The monitor circuit 220 may be conceptually, though not necessarily physically, divided into an LED-current emulator 400, a comparator 402, and a sample-compare circuit 404. The example LED-current emulator 400 defines the switch-node input 324, a sawtooth output 406, and an average output 408. The example comparator 402 defines a non-inverting input 410 coupled to the sawtooth output 406, an inverting input 412 coupled to the average output 408, and a compare output 414. The example sample-compare circuit 404 defines the mode input 328, the sense input 322, the sense input 316, the source input 326, and the fault output 244. The sample-compare circuit 404 further defines a sample-trigger input 416 coupled to compare output 414.

The monitor circuit 220 makes a determination as to whether the average current supplied to the LED 106 (FIG. 1) is outside a predetermined range of values. In example cases, the determination is made without sensing current flow to the LED using devices outside the driver circuit 102 to directly measure the current. More particularly, in various examples the monitor circuit makes its determination without using a shunt resistor external to the driver circuit 102 to directly measure the current. Moreover, the monitor circuit 220 makes its determination without using the current sensing elements used by the regulator 218 (FIG. 2) to create the regulation signal. In example cases, in order to perform the monitoring the LED-current emulator 400 creates an emulation signal that is indicative of inductor current. Inasmuch as the current supplied to the inductor 104 and LED 106 has a sawtooth shape, the emulation signal likewise has a sawtooth shape and is hereafter referred to as the sawtooth waveform. Additionally, the LED-current emulator 400 creates and drives an average signal to the average output 408, and in steady state conditions the magnitude of the average signal is about equal to the average value of the sawtooth waveform driven to the sawtooth output 406.

Still referring to FIG. 4, and turning now to the comparator 402, the example comparator 402 has the non-inverting input 410 coupled the sawtooth waveform and has the inverting input 412 coupled to the average signal. When the sawtooth waveform crosses the average signal, the comparator 402 asserts the compare output 414 to the sample-compare circuit 404. More precisely for the example setup, when the magnitude of the sawtooth waveform rises through the magnitude of the average signal, the comparator 402 asserts the compare output 414.

The example sample-compare circuit 404 is designed and constructed to create the monitor signal by sampling a signal indicative of voltage across the low-side FET 204 (FIG. 2), the sample taken during discharge modes of the inductor 104. More particularly, during periods of time when the mode input 328 is asserted, the gate of the low-side FET 204 is asserted, and thus the LED module 100 (FIG. 1) is in the discharge mode. The sample-compare circuit 404 is designed and constructed measure a voltage on one or both of the sense input 316 and/or sense input 322 at the point in time when sample-trigger input 416 is asserted by the comparator 402. Stated in terms of signals, when the magnitude of the sawtooth waveform crosses the magnitude of the average signal (as determined by the comparator 402), the sample-compare circuit 404 measures a voltage on one or both of the sense input 316 and/or sense input 322 to create the monitor signal. If the monitor signal is outside a predetermined range of values, the sample-compare circuit 404 is designed and constructed to assert the fault signal driven to the fault output 244. Before turning to a specific example implementation, the specification turns to an example timing diagram.

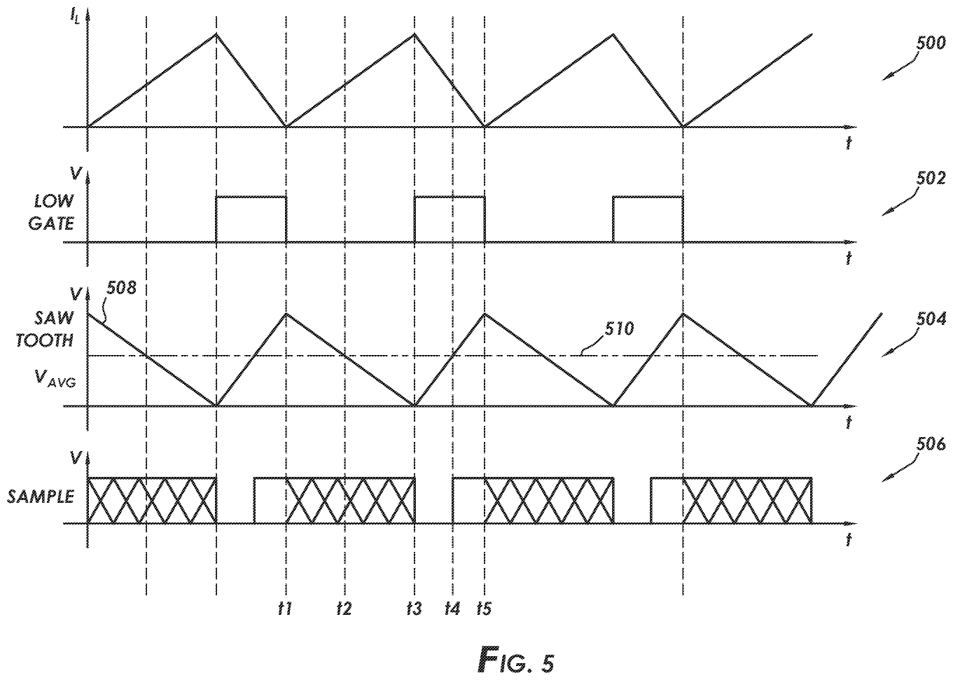

FIG. 5 shows an example timing diagram. In particular, FIG. 5 includes: plot 500 showing inductor current IL as a function time; plot 502 showing the voltage applied to the gate of the low-side FET 204 as a function of time; plot 504 showing an emulated sawtooth waveform as a function of time, and a co-plotted average signal (V_{AVG}); and plot 506 showing a sample signal applied to the sample-compare circuit 404 as a function of time. The plots are along corresponding time axes.

In particular, FIG. 5 shows three complete and one partial switching periods for the example LED module 100 (FIG. 1). Plot 500, for example, shows an example charge mode between times t1 and t3, and an example discharge mode between times t3 and t5. During the charge mode, the inductor current inductor current IL rises from a low value to a peak value (e.g., the peak value set by the regulator 218). During the discharge mode current falls from the peak value until the next charge mode begins. Stated otherwise, the time period between times t1 and t3 is an example on-time of the charge mode in which the high-side FET 202 (FIG. 2) is conductive and the low-side FET 204 (FIG. 2) is non-conductive, and the time period between times t3 and t5 is an example off-time of the discharge mode in which the high-side FET 202 is non-conductive and the low-side FET 204 is conductive. It is noted that in various examples the inductor current IL is not directly measured; however, the inductor is current is shown in the timing diagram for reference purposes.

Plot 502 shows an example signal provided to the gate 216 of the low-side FET 204, hereafter the low-gate signal. The gate 210 of the high-side FET 202 receives a signal that is a logical NOT of the low-gate signal of plot 502; however, the signal applied to the gate of the high-side FET 202 is not show so as not to further complicate the figure. The example low-gate signal is shown de-asserted between times t1 and t3, and asserted (e.g., asserted high) between times t3 and t5. During times when the gate 216 of the low-side FET 204 is asserted, the low-side FET 204 is conductive (e.g., discharge modes). During times when the gate 216 of the low-side FET 204 is de-asserted, the low-side FET 204 is non-conductive (e.g., charge modes).

Plot 504 shows an example sawtooth waveform 508 created by the LED-current emulator 400. For convenience of the circuit design, the sawtooth waveform 508 is a mirror image of the inductor current IL, but with the benefit of this disclosure one of ordinary skill could create a monitor circuit that operates with a sawtooth waveform with polarity that matches the inductor current IL. In accordance with example cases, the points in time when the magnitude of the sawtooth waveform 508 crosses the magnitude of the average signal is the trigger to sample to create the monitor signal. Co-plotted with the sawtooth waveform 508 is the average signal V_{AVG} 510 that represents the average value of the sawtooth waveform 508. Considering the switching period between times t1 and t5, and specifically the discharge mode between times t3 and t5 (e.g., when the low gate of plot 502 is asserted), the sawtooth waveform 508 crosses (e.g., rises through) the average signal V_{AVG} 510 at time t4

Plot 506 shows an example sample signal as applied to the sample-trigger input 416 of the sample-compare circuit 404. Stated otherwise, the sample signal of plot 506 is the signal created and driven by the comparator 402 (FIG. 4) to the compare output 414 (FIG. 4). During each discharge mode, when the low-gate signal is asserted, the sample signal goes asserted (e.g., asserted high as shown) when the magnitude of the sawtooth waveform 508 rises through the magnitude of the average signal V_{AVG} 510. Inasmuch as the sawtooth waveform 508 is an emulation of the inductor current, and further that the average signal is an average value of the sawtooth waveform, the instant in time at which the magnitude of the sawtooth waveform 508 rises through the magnitude of the average signal V_{AVG} should closely represent the instant in time when the inductor current IL falls through its average value. Thus, by sampling at the noted time, a signal indicative of the average current to the LED is created—the monitor signal. Inasmuch as the example discussed to this point measures a signal indicative of the voltage drop across the low-side FET 204 during the discharge mode, the sampling may be said to create a signal indicative of current through the low-side FET 204. Thus, in the example system the rising edge of the sample signal is the trigger for sampling to create the monitor signal. The state of the sample signal during charge modes (e.g., times t1 to t3) is a “don't care” condition, and thus shown as indeterminate in the example plot 506.

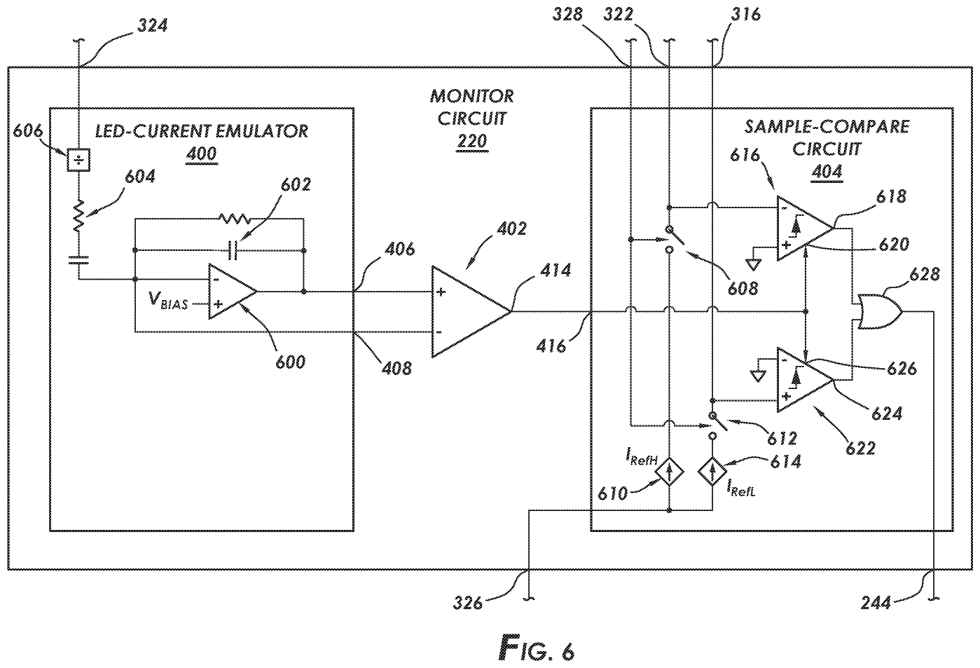

FIG. 6 shows a partial block diagram, partial electrical schematic, of an example monitor circuit 220 in greater detail. In particular, FIG. 6 shows the LED-current emulator 400, the comparator 402, and the sample-compare circuit 404. In example systems, the LED-current emulator 400 creates the sawtooth waveform by integrating a signal indicative of voltage on the switch-node terminal 110. More particularly, the voltage at the switch-node terminal 110 (FIG. 1) cycles between the input voltage VIN (during the charge mode) and slightly below ground (during the discharge mode). The example LED-current emulator 400 creates the sawtooth waveform by integrating over time the voltage on the switch-node terminal 110. The integration results in the sawtooth waveform having an average value. The example LED-current emulator 400 provides the sawtooth waveform to the sawtooth output 406, and provides the average value of the sawtooth waveform to the average output 408.

The example LED-current emulator 400 comprises an operational amplifier 600 configured for integration, as shown by the capacitor 602 coupled between the inverting input and the integrated output of the operational amplifier 600. In particular, the voltage of the switch-node terminal 110 (applied through the switch-node input 324) is coupled to the inverting input of the operational amplifier 402 by way of a filter network 604. The voltage at the switch-node input 324 may be optionally scaled down by a voltage divider 606. The integrated output of the operational amplifier 600 is coupled to and defines the sawtooth output 406. The non-inverting input of the operational amplifier 600 is coupled to a bias voltage V_{BIAS}. So long as bias voltage V_{BIAS} is within the operating range of the operational amplifier 600, the bias voltage V_{BIAS} may be selected at the discretion of the circuit designer. It turns out that the bias voltage V_{BIAS} will be the average value of the integration performed by the operational amplifier 600. In the example shown the inverting input of the operational amplifier 600 (which very closes matches the bias voltage V_{BIAS}) is coupled to the average output 408 to be provided to the comparator 402. The various components of the LED-current emulator 400 are merely an example. One of ordinary skill, now understanding the functions of the LED-current emulator 400, could create many alternative circuits to create the sawtooth waveform and the average signal.

Still referring to FIG. 6, and in particular the sample-compare circuit 404. Again, the example sample-compare circuit 404 is designed and constructed to assert the fault signal on the fault output 244 if the monitor signal (e.g., indicative of average current to the switch-node terminal 110, inductor 104, and LED 106) is outside the predetermined range of values. To that end, the example sample-compare circuit 404 comprise a first electrically-controlled switch 608 illustratively shown as a single-pole single-throw switch, but in practice may be implemented as a transistor (e.g., a FET). The switch 608 has first connection that defines the sense input 322, a second connection, and a control input coupled to the mode input 328. In example cases, switch 608 is closed, and thus conductive, during periods of time when the mode input 328 is asserted. Stated differently, in example cases the switch 608 may be conductive during discharge modes of the LED module 100. The second connection of the switch 608 is coupled to a current output of a current source 610, and the current input of the current source 610 is coupled to the input voltage VIN by way of the source input 326. Thus, during periods of time when the switch 608 is conductive (e.g., discharge modes), a predetermined current I_{RefH} flows through the switch 608, and then through the low-mirror FET 310 (FIG. 3), and then to the switch-node terminal 110 and thus the inductor 104 and the LED 106.

In the example system, the I_{RefH} current provided by the current source 610 creates a voltage across the low-mirror FET 310 proportional to the magnitude of the input voltage VIN and the Rdson of the low-mirror FET 310. That is, the Rdson of the low-mirror FET 310 is closely related to the Rdson of the low-side FET 204, and thus voltage developed across the low-mirror FET 310 is proportional to the voltage drop across the low-side FET 204 during the discharge mode.

The example sample-compare circuit 404 further comprises a second electrically-controlled switch 612 illustrative shown as a single-pole single-throw switch, but in practice may be implemented as a transistor (e.g., a FET). The switch 612 has first connection that defines the sense input 316, a second connection, and a control input coupled to the mode input 328. In example cases, the switch 612 is closed, and thus conductive, during periods of time when the mode input 328 is asserted. Stated differently, in example cases the switch 612 may be conductive during discharge modes of the LED module 100. The second connection of the switch 612 is coupled to a current output of a current source 614, and the current input of the current source 614 is coupled to the input voltage VIN by way of the source input 326. Thus, during periods of time when the switch 612 is conductive (e.g., discharge modes), a predetermined current I_{RefL} flows through the switch 614, and then through the low-mirror FET 308 (FIG. 3), and to the switch-node terminal 110.

In the example system, the I_{RefL} current provided by the current source 614 creates a voltage across the low-mirror FET 308 proportional to the magnitude of the input voltage VIN and the Rdson of the low-mirror FET 308. That is, the Rdson of the low-mirror FET 308 is closely related to the Rdson of the low-side FET 204, and thus voltage developed across the low-mirror FET 308 is proportional to the voltage drop across the low-side FET 204 during the discharge mode.

The sample-compare circuit 404 further defines a high comparator 616 and a low comparator 622. The example high comparator 616 defines an inverting input coupled to the sense input 322, a non-inverting input coupled to a reference voltage, a high-compare output 618, and high-sample input 620. The example low comparator 622 defines a non-inverting input coupled to the sense input 316, an inverting input coupled to a reference voltage, a low-compare output 624, and a low-sample input 626. The example high comparator 616 and low comparator 622 are rising-edge triggered comparators, meaning that each comparator samples its inputs and drives is output on the rising edge of a trigger signal applied to the sample input. In the example circuit, the sample-trigger input 416 is coupled to the high-sample input 620 and the low-sample input 626. It follows that in the example shown, the high comparator 616 and the low comparator 622 sample their respective inputs, and drive their respective outputs, each time the sawtooth waveform crosses the average value (e.g., time t4 of FIG. 5). Finally, the example sample-compare circuit 404 incudes a logic OR gate 628 defining a first input coupled to the high-compare output 618, a second input coupled to the low-compare output 624, and a logic output coupled to and defining the fault output 244.

In various examples, the current sources 610 and 614 create the predetermined range of values for the average current, outside of which the sample-compare circuit 404 asserts the fault signal driven to the fault output 244. Referring to the overall monitor circuit 220, during the discharge mode when the mode input 328 is asserted, the LED-current emulator 400 creates and drives the sawtooth waveform to the sawtooth output 406, and creates and drives the average signal to the average output 408. When the magnitude of sawtooth waveform rises through the magnitude of the average signal, the comparator 402 asserts the compare output 414 and thus the sample-trigger input 416. Responsive to assertion of the sample-trigger input 416, the comparators 618 and 622 compare the monitor signals to the reference voltages. If the monitor signal created by the I_{RefH} current source 610 through the low-mirror FET 310 (FIG. 3) is above a reference (e.g., above the ground reference), the high-compare output 618 of the high comparator 616 is asserted, and thus the logic OR gate 628 asserts the fault signal to the fault output 244. If the monitor signal created by the I_{RefL} current source 614 through the low-mirror FET 308 (FIG. 3) is above a reference (e.g., above the ground reference), the low-compare output 624 of the low comparator 622 is asserted, and thus the logic OR gate 628 asserts the fault signal to the fault output 244. On the other hand, if the monitor signal(s) indicate an average current is within the predetermined range of values, then the high-compare output 618 and the low-compare output 624 remain de-asserted, and thus the logic OR gate 628 does not assert the fault output 244.

With respect to the monitoring during the discharge mode by the monitor circuit 220, the description returns briefly to FIG. 3. During the discharge mode, the inductor current flows through the low-side FET 204. The example monitor circuit 220 samples at the point in time at which the instantaneous current should equal the setpoint average current. If a fault has occurred (e.g., major shift of Rdson of the high-side FET 202), the actual average current will be higher or lower than the setpoint average current. Consider first that the LED module 100 is operating properly. At the point in time during each discharge mode at which the sample is taken, the voltage on the switch-node terminal 110 will be a negative value referenced to ground (e.g., V_{SW}=−I_{AVG}×Rdson). If the actual average current is much higher than the setpoint average current, then the voltage at the switch-node terminal 110 at the point in time at which the sample is taken will be more negative. Oppositely, if the actual average current is much lower than the setpoint average current, then the voltage at the switch-node terminal 110 at the point in time at which the sample is taken will be less negative, closer to ground potential. Note that the drains of the low-mirror FETs 308 and 310 are coupled to the switch-node terminal 110.

Returning to FIG. 6, the currents of the I_{RefH} current source 610 and IRefL current source 614 are selected define the predetermined range outside which the fault terminal 124 is asserted. If the actual average current closely matches the setpoint average current, given the polarity of the voltage developed across the low-mirror FET 310, the monitor signal created by the I_{RefH} current source 610 and applied to the inverting input of the high comparator 616 will be positive, and thus above the ground reference coupled to the non-inverting input of the high comparator 616. It follows the high comparator 616 will not assert its compare output 618. Similarly, with the actual average current closely matching the setpoint average current, given the polarity of the voltage developed across the low-mirror FET 308, the monitor signal created by the I_{RefL} current source 614 and applied to the non-inverting input of the low comparator 622 will be negative, and thus below the ground reference coupled to the inverting input of the high comparator 616. It follows the low comparator 622 will not assert its compare output 624.

If the actual average current is much greater than the setpoint average current, given the polarity of the voltage developed across the low-mirror FET 310, the monitor signal created by the I_{RefH} current source 610 and applied to the inverting input of the high comparator 616 will be negative. Thus, the non-inverting input of the high comparator 616 will have a higher voltage than the inverting input, and thus the comparator output 618 will be asserted. Oppositely, if actual average current is very low or zero, given the polarity of the voltage developed across the low-mirror FET 308, the monitor signal created by the I_{RefL} current source 614 and applied to the non-inverting input of the low comparator 622 will be positive, and thus above the ground reference coupled to the non-inverting input of the high comparator 616. Thus, the comparator output 624 will be asserted.

Returning to FIG. 2. The various examples discussed to this point are based on the regulator 218 creating the regulation signal by directly or indirectly measuring a voltage drop across the high-side FET 202 during each charge mode, and adjusting the peak current for the charge modes based on the regulation signal. Similarly, the various examples discussed to this point are based on the monitor circuit 220 creating the monitor signal(s) by directly or indirectly measuring a voltage drop across the low-side FET 204 during each discharge mode, and asserting the fault signal if the monitor signal(s) indicate the average inductor current is outside a predetermined range of values. However, creating the regulation signal may alternatively take place by directly or indirectly measuring a voltage drop across the low-side FET 204 during each discharge mode, and the regulator 218 adjusting the peak current in a subsequent (e.g., immediately subsequent) charge mode based on the regulation signal. Similarly, creating the monitor signal may alternatively take place by directly or indirectly measuring a voltage drop across the high-side FET 202 during each charge mode, and again asserting the fault signal if the monitor signal indicates the average inductor current is outside a predetermined range of values.

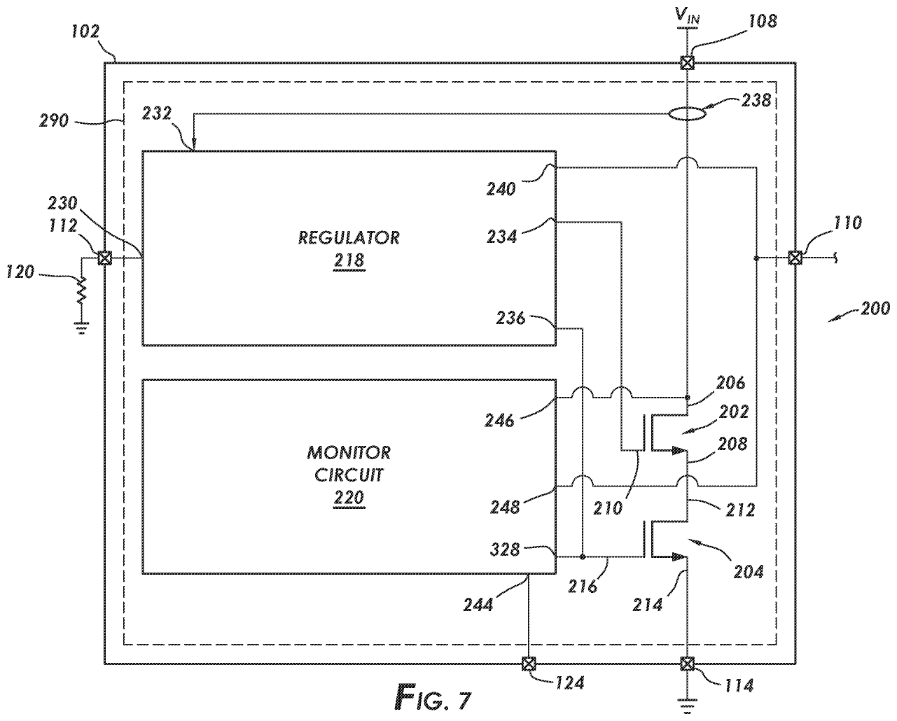

FIG. 7 shows a block diagram of another example driver circuit 102. The example driver circuit of FIG. 7 shares many duplicative elements with the driver circuit of FIG. 2, and those duplicative elements may not be introduced again so as not to unduly lengthen the specification. In the driver circuit 102 of FIG. 7, the example regulator 218 again defines the setpoint input 230 coupled to the setpoint terminal 112, the current-sense input 232 coupled to the current sensor 238, the high-gate output 234 coupled to the gate 210 of the high-side FET 202, and the low-gate output 236 coupled to the gate 216 of the low-side FET 204. As before, the regulator 218 is designed and constructed to drive a plurality of charge modes and discharge modes of the inductor 104 (FIG. 1). And again as before, the example regulator 218 ends each charge mode based on a peak current sensed through the current-sense input 232. The peak current selected for each charge mode may be different and may be determined based on the signal indicative of average current—the regulation signal.

In the example system of FIG. 7, the regulation signal may be derived from a signal indicative of voltage drop across the low-side FET 204 during each discharge mode. In FIG. 7, the regulation signal in the form of the voltage drop across the high-side FET 202 is measured directly. In particular, the example regulator 218 defines the first sense input 240 coupled to the drain 212 of the low-side FET 204, where the drain of the low-side FET 204 is also coupled to the switch-node terminal 110. The example regulator 218 selects the peak current for a charge mode based on the regulation signal derived in a prior discharge mode, and in some cases the immediately prior discharge mode.

Inasmuch as one goal of functional safety monitoring is to achieve redundant current measurements, in cases in which the regulation signal is derived from the low-side FET 204, the monitor circuit 220 may derive the monitor signal from the high-side FET 202 during each charge mode. In the example of FIG. 7, the monitor signal may be derived from a signal indicative of voltage drop across the high-side FET 202 during each charge mode. The state of the charge mode may be determined by the mode input 328 coupled to the gate 216 of the low-side FET 204, or any other suitable location (e.g., the gate 210 of the high-side FET 202). In FIG. 7, the monitor signal in the form of the voltage drop across the low-side FET 204 is measured directly. In particular, the example monitor circuit 220 defines the first sense input 246 coupled to the drain 206 of the high-side FET 202. The example monitor circuit 220 further defines the second sense input 248 coupled source 208 of the high-side FET 202. The example monitor circuit 220 is designed and constructed to create the monitor signal by measuring or sensing the voltage drop across the high-side FET 202 using the first sense input 246 and the second sense input 248. If the monitor signal is outside the predetermined range of values, meaning the overall driver circuit 102 may not be correctly providing the setpoint average current, the fault signal driven to the fault output 244 is asserted.

Now understanding that the regulation signal can be derived from the low-side FET 204 directly rather than the high-side FET 202, and that the monitor signal can be derived from the high-side FET 202 directly rather than the low-side FET 204, one of ordinary skill could likewise arrange the regulator 218 and monitor circuit 220 to indirectly measure using the mirror FETs presented above and discussed with respect to FIG. 3.

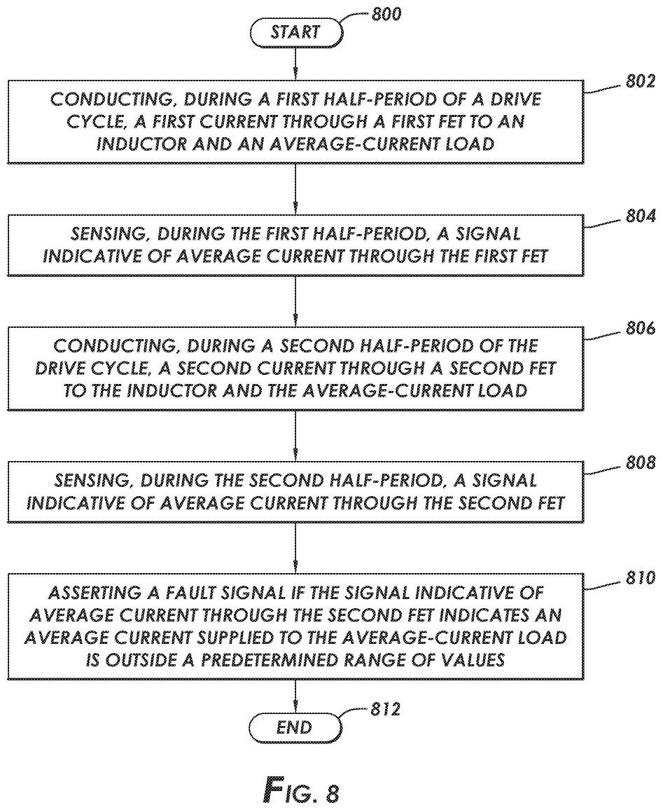

FIG. 8 shows a method in accordance with at least some embodiments. In particular, the method starts (block 800) and comprises: conducting, during a first half-period of a drive cycle, a first current through a first FET to an inductor and an LED (block 802); sensing, during the first half-period, a signal indicative of average current through the first FET (block 804); and then conducting, during a second half-period of the drive cycle, a second current through a second FET to the inductor and the LED (block 806); sensing, during the second half-period, a signal indicative of average current through the second FET (block 808); and asserting a fault signal if the signal indicative of average current through the second FET indicates an average current supplied to the LED is outside a predetermined range of values (block 810). Thereafter the method ends (block 812), to be restarted on the next cycle.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
conducting, during a first half-period of a drive cycle, a first current through a first FET to an inductor and an average-current load;
sensing, during the first half-period, a signal indicative of average current through the first FET; and then
conducting, during a second half-period of the drive cycle, a second current through a second FET to the inductor and the average-current load;
sensing, during the second half-period, a signal indicative of average current through the second FET; and
asserting a fault signal if the signal indicative of average current through the second FET indicates an average current supplied to the average-current load is outside a predetermined range of values.

2. The method of claim 1:
wherein conducting the first current further comprises driving current through the first FET during a charge mode of the inductor during the drive cycle;
wherein conducting current through the second FET further comprises conducting current through the second FET during a discharge mode of the inductor during the drive cycle.

3. The method of claim 1:
wherein sensing the signal indicative of average current through the first FET further comprises reading a signal indicative of voltage drop across the first FET; and
wherein sensing the signal indicative of average current through the second FET further comprises reading a signal indicative of voltage drop across the second FET.

4. The method of claim 1:
wherein sensing the signal indicative of average current through the first FET further comprises measuring a voltage drop across the first FET; and
wherein sensing the signal indicative of average current through the second FET further comprises measuring a voltage drop across the second FET.

5. The method of claim 1 further comprising:
generating a sawtooth waveform that corresponds to the first current and the second current;
wherein sensing the signal indicative of average current through the first FET further comprises sampling to create the signal indicative of average current through the first FET, the sampling at a point in time within the first half-period when the sawtooth waveform crossing a signal indicative of setpoint average current; and
wherein sensing the signal indicative of average current through the second FET further comprises sampling to create the signal indicative of average current through the second FET, the sampling at a point in time within the second half-period corresponding to the sawtooth waveform crossing the signal indicative of setpoint average current.

6. The method of claim 1:
wherein sensing the signal indicative of average current through the first FET further comprises measuring a voltage drop across or current through a first mirror-FET associated with the first FET; and
wherein sensing the signal indicative of average current through the second FET further comprises measuring a voltage drop across or current through a second mirror-FET associated with the second FET.

7. A driver for an LED, the driver comprising:
a setpoint terminal, an input-voltage terminal, a switch-node terminal, and a return terminal;
a high-side FET defining drain coupled to the input-voltage terminal, a source coupled to the switch-node terminal, and a gate;
a low-side FET defining a drain coupled to the switch-node terminal, a source coupled to the return terminal, and a gate;
a regulator defining a setpoint input coupled to the setpoint terminal, a high-gate output coupled to the gate of the high-side FET, and a low-gate output coupled to the gate of the low-side FET, the regulator configured to assert the high-gate output and de-assert the low-gate output to create charge modes of an inductor, and the regulator configured to de-assert the high-gate output and assert the low-gate output to create discharge modes of the inductor;
the regulator configured to control an on-time of each charge mode based on a first signal indicative of average current to the switch-node terminal; and
a monitor circuit coupled to the switch-node terminal, the monitor circuit configured to sense a second signal indicative of average current to the switch-node terminal and assert a fault signal if the second signal indicative of average current to the switch-node terminal is outside a predetermined range of values.

8. The driver of claim 7 wherein when the monitor circuit senses the second signal indicative of average current to the switch-node terminal, the monitor circuit reads a signal indicative of voltage drop across the low-side FET during a discharge mode.

9. The driver of claim 8 further comprising:
a low-mirror FET having a bulk region adjacent to a bulk region of the low-side FET, the low-mirror FET defining a first connection coupled to the switch-node terminal, a second connection coupled to a reference voltage, and a gate coupled to the gate of the low-side FET;
wherein when the monitor circuit reads the signal indicative of voltage drop across the low-side FET, the monitor circuit measures a voltage drop across or current through the low-mirror FET.

10. The driver of claim 8 wherein the regulator is further configured determine the first signal indicative of average current to the switch-node terminal by reading a signal indicative of voltage drop across the high-side FET during a charge mode.

11. The driver of claim 10 further comprising:
a high-mirror FET having a bulk region adjacent to a bulk region of the high-side FET, the high-mirror FET defining a first connection coupled to input-voltage terminal, a second connection coupled to a reference voltage, and a gate coupled to the gate of the high-side FET;
wherein when the regulator reads the signal indicative of voltage drop across the high-side FET, the regulator measures a voltage drop across or current through the high-mirror FET.

12. The driver of claim 7 wherein when the monitor circuit senses the second signal indicative of average current to the switch-node terminal, the monitor circuit reads a signal indicative of voltage drop across the high-side FET during a charge mode.

13. The driver of claim 12 wherein the regulator is further configured determine the first signal indicative of average current to the switch-node terminal by reading a signal indicative of voltage drop across the low-side FET during a discharge mode.

14. An LED module comprising:
an LED;
an inductor defining a first lead coupled to an anode of the LED, and a second lead defining a switch node;
a setpoint resistor defining a first lead coupled to a reference voltage and a second lead, a resistance of the setpoint resistor is proportional to a setpoint average current for the LED;
a driver comprising:
high-side FET defining a drain coupled to a input voltage, a source coupled to the switch node, and a gate;
a low-side FET defining a drain coupled to the switch node, a source coupled to a return, and a gate;
regulator defining a setpoint input coupled to the second lead of the setpoint resistor, a high-gate output coupled to the gate of the high-side FET, and a low-gate output coupled to the gate of the low-side FET, the regulator configured to drive a plurality of charge modes and discharge modes of the inductor based on a first signal indicative of average current to the switch node; and
a monitor circuit coupled to the switch node, the monitor circuit configured to sense a second signal indicative of average current to the switch node and assert a fault signal if the second signal indicative of average current to the switch node is outside a predetermined range of values.

15. The LED module of claim 14 wherein when the monitor circuit senses the second signal indicative of average current to the switch node, the monitor circuit reads a signal indicative of voltage drop across the low-side FET during a discharge mode.

16. The LED module of claim 15 wherein the driver further comprises:
a low-mirror FET having a bulk region adjacent to a bulk region of the low-side FET, the low-mirror FET defining a first connection coupled to the switch node, a second connection coupled to a reference voltage, and a gate coupled to the gate of the low-side FET;
wherein when the monitor circuit reads the signal indicative of voltage drop across the low-side FET, the monitor circuit measures a voltage drop across the low-mirror FET.

17. The LED module of claim 15 wherein the regulator is further configured determine the first signal indicative of average current to the switch node by reading a signal indicative of voltage drop across the high-side FET during a charge mode.

18. The LED module of claim 17 wherein the driver further comprises:
a high-mirror FET having a bulk region adjacent to a bulk region of the high-side FET, the high-mirror FET defining a first connection coupled to the input voltage, a second connection coupled to a reference voltage, and a gate coupled to the gate of the high-side FET;
wherein when the regulator reads the signal indicative of voltage drop across the high-side FET, the regulator measures a voltage drop across the high-mirror FET.

19. The LED module of claim 14 wherein when the monitor circuit senses the second signal indicative of average current to the switch node, the monitor circuit reads a signal indicative of voltage drop across the high-side FET during a charge mode.

20. The LED module of claim 19 wherein the regulator is further configured determine the first signal indicative of average current to the switch node by reading a signal indicative of voltage drop across the low-side FET during a discharge mode.

21. The LED module of claim 14 wherein the monitor circuit further comprises:
an LED-current emulator coupled to the switch node and configured to integrate a voltage on the switch node and create a sawtooth waveform having an average value;
a comparator having a first input coupled to the sawtooth waveform, a second input coupled to an average signal, and a comparator output, the comparator configured to assert the comparator output when the sawtooth waveform crosses the average signal;
a sample-compare circuit coupled to the switch node and the comparator output, the sample-compare circuit configured to measure the second signal indicative of average current to the switch node responsive to assertion of the comparator output; and
the sample-compare circuit configured to assert the fault signal if the second signal indicative of average current to the switch node is outside the predetermined range of values.
